(19) United States
(12) Patent Application Publication
(10) Pub. No.: US 2024/0190031 A1
(43) Pub. Date: Jun. 13, 2024

(54) CUTTER HEAD ASSEMBLY WITH GUIDE STRUCTURE AND WRENCH ADJUSTMENT MECHANISM OF ELECTRIC HAIR CUTTER

(71) Applicant: NINGBO ICLIPPER ELECTRIC APPLIANCE CO., LTD., Ningbo (CN)

(72) Inventor: Haoze WU, Ningbo (CN)

(21) Appl. No.: 18/237,498

(22) Filed: Aug. 24, 2023

(30) Foreign Application Priority Data
Dec. 8, 2022 (CN) 2023200276196
Jan. 6, 2023 (CN) 2023200276092

(51) Int. Cl. B26B 19/20; B26B 19/06

(52) U.S. Cl. CPC B26B 19/205; B26B 19/06

(57) ABSTRACT

A cutter head assembly with a guide structure, includes a bottom plate, a fixed blade holder, a fixed blade, a movable blade holder, a movable blade, and a torsion spring, the fixed cutter holder is slidably arranged on the bottom plate, the fixed blade is fixedly connected to the fixed cutter holder, and the movable blade is arranged on the movable cutter holder; the torsion spring is fixedly mounted on the bottom plate or the fixed cutter holder; two ends of the torsion spring act on the movable cutter holder or the movable blade; a transversely-arranged guide rod is fixedly mounted on the bottom plate, and an end of the movable cutter holder corresponding to the movable blade is provided with a guide groove interacting with the guide rod, a portion of the bottom plate corresponding to the movable cutter holder is provided with an avoidance groove.

### TECHNICAL FIELD

This invention generally relates to the technical field of electric hair cutters, and more particularly, to a cutter head assembly with a guide structure and a wrench adjustment mechanism of an electric hair cutter.

### BACKGROUND

An electric hair cutter is an electric tool for cutting hair, which is extensively used in people's daily lives. A conventional cutter head assembly of an electric hair cutter comprises a fixed cutter holder, a movable cutter holder, a fixed blade, a movable blade and a torsion spring. The fixed blade is fixedly mounted on the fixed cutter holder, the movable blade is fixedly connected to the movable cutter holder or inserted into the movable cutter holder, and the torsion spring is fixedly mounted on a bottom shell or the fixed cutter holder at the front end of the electric hair cutter. The two ends of the torsion spring act on the movable cutter holder or the movable blade to enable the movable blade to be attached to the fixed blade, and a motor of the electric hair cutter propels the movable blade to reciprocate relative to the fixed blade through an eccentric mechanism such that the hair is cut.

When the motor propels the movable blade to reciprocate relative to the fixed blade by means of an eccentric mechanism, the moving path of the movable blade is fan-shaped. Namely, when the movable blade moves to the two sides of the fixed blade, the height of the tooth portion of the fixed blade and the tooth portion of the movable blade is obviously higher than the height of the tooth portion of the fixed blade and the tooth portion of the movable blade when the movable blade moves to the middle of the fixed blade. In other words, the height between the tooth portion of the movable blade and the tooth portion of the fixed blade in the operation of the movable blade cannot be kept consistent, resulting in different lengths of the cut hair.

In addition, to change the front-back distance between the fixed blade and the movable blade during the operation of the electric hair cutter to control the length of the cut hair, normally, a wrench adjustment mechanism is arranged on the electric hair cutter. For example, a wrench adjustment mechanism disclosed in Chinese patent CN213106940U comprises a guide rail arranged at the top end of a main body, wherein a fixed cutter holder is slidably mounted on the guide rail, a fixed blade is connected to the top of the fixed cutter holder, and an adjustment wrench portion is arranged on one side of the main body. The adjustment wrench portion is capable of rotating relative to the fixed cutter holder while pushing the fixed cutter holder to slide along the guide rail. The rotation of the adjustment wrench portion allows a shift lever to rotate along with the adjustment wrench portion. Moreover, because the moving path of the shift lever is non-circular, a push rod connected to the adjustment wrench portion is capable of pushing the fixed cutter holder to move back and forth when the adjustment wrench portion rotates, which enables the fixed blade fixedly connected to the fixed cutter holder to move back and forth.

However, the external shift lever structure has shortcomings including low positioning precision, large occupied space and high manufacturing cost. Therefore, it is urgent for those skilled in the art to develop a novel structure.

### SUMMARY

The purpose of the present invention is to provide a cutter head assembly with a guide structure, wherein a guide rod is arranged in a bottom plate, thereby allowing a movable cutter holder to move back and forth along the length direction of the guide rod such that the consistency of the cut hair is ensured. Moreover, the present invention also provides a wrench adjustment mechanism of an electric hair cutter, wherein through the interaction between a fixed tooth block in a wrench portion and a bevel tooth portion, the wrench portion is precisely positioned, so that problems relating to low positioning accuracy, large occupied space and high manufacturing cost of the conventional wrench adjustment mechanism are solved.

To achieve the above purpose, the present invention adopts the following technical solution: a cutter head assembly with a guide structure comprises a bottom plate, a fixed blade holder, a fixed blade, a movable blade holder, a movable blade and a torsion spring, wherein the fixed cutter holder is slidably arranged on the bottom plate, the fixed blade is fixedly connected to the fixed cutter holder, and the movable blade is arranged on the movable cutter holder, wherein the torsion spring is fixedly mounted on the bottom plate or the fixed cutter holder, and two ends of the torsion spring act on the movable cutter holder or the movable blade to enable the movable blade to be attached to the fixed blade, wherein a transversely-arranged guide rod is fixedly mounted on the bottom plate, and the other end of the movable cutter holder corresponding to the movable blade is provided with a guide groove interacting with the guide rod in a guiding manner, wherein a portion of the bottom plate corresponding to the movable cutter holder is provided with an avoidance groove for allowing the movable cutter holder to reciprocate transversely.

In another embodiment of the present invention, mounting portions are arranged on two sides of the bottom plate corresponding to the avoidance groove, a first mounting groove interacting with an end portion of the guide rod is formed in the mounting portion. The end surfaces of two first mounting grooves limit the guide rod to move in a direction perpendicular to the insertion direction, a limiting protrusion is arranged on the mounting portion, and the limiting protrusion limits the guide rod to move along the insertion direction.

In another embodiment of the present invention, an upper end of the limiting protrusion is provided with a guide inclined surface for allowing the guide rod to conveniently insert into the first mounting groove.

In another embodiment of the present invention, one end of the movable cutter holder corresponding to the guide rod is provided with a first mounting block, and the first mounting block is provided with a guide groove matched with the outer diameter of the guide rod. The movable cutter holder is inserted into the guide rod through the guide groove and is capable of reciprocating transversely along the guide rod.

In another embodiment of the present invention, the longitudinal section of the guide groove is configured to be a U-shaped structure.

In another embodiment of the present invention, an oil storage groove is provided at an inner end of the movable cutter holder corresponding to the guide groove, and an oil storage sponge is arranged in the oil storage groove. The guide rod is in contact with the oil storage sponge, and the oil storage sponge is prevented from falling off from the oil storage groove by means of the guide rod.

In another embodiment of the present invention, when the oil storage sponge is not pressed, an outer end of the oil storage sponge extends out from the oil storage groove.

In another embodiment of the present invention, an insertion block is arranged at the other end of the movable cutter holder corresponding to the guide rod, and the movable blade is provided with a first slot for interacting with the insertion block.

The present invention also provides a wrench adjustment mechanism of an electric hair cutter comprising a cutter head assembly and a wrench assembly, wherein the cutter head assembly comprises a bottom plate, a fixed cutter holder, a fixed blade, a movable cutter holder, a movable blade and a torsion spring. The fixed cutter holder is slidably arranged on the bottom plate. The wrench assembly comprises a wrench portion and a spring, wherein the wrench portion is rotatably connected to the bottom plate through a pin shaft, and a driving column is arranged at an eccentric position at an inner end of the wrench portion. The fixed cutter holder is provided with a second slot for interacting with the driving column in an inserting manner, and a fixed tooth block rotating synchronously with the wrench portion is arranged in the wrench portion. The wrench portion or the pin shaft is provided with a bevel tooth portion engaged with the tooth surface of the fixed tooth block, and the spring abuts between the inner end surface of the wrench portion and the fixed tooth block, so that the fixed tooth block possesses a trend of moving towards one side of the bevel tooth portion.

In another embodiment of the present invention, an outer side of the pin shaft is provided with a nut portion, and the nut portion is used to prevent the wrench portion and the fixed tooth block from being separated from the pin shaft. The bevel tooth portion is arranged on an inner end surface of the nut portion.

In another embodiment of the present invention, the other side of the pin shaft corresponding to the nut portion is provided with a threaded portion having an outer diameter smaller than that of the pin shaft, and a step portion is formed between the threaded portion and the pin shaft.

In another embodiment of the present invention, the fixed tooth block comprises a positioning block and a bevel tooth block connected to the positioning block, wherein the bevel tooth block is provided with a positioning bevel tooth portion engaged with the tooth surface of the bevel tooth portion. An inner wall of the wrench portion is provided with a positioning groove interacting with the positioning block.

In another embodiment of the present invention, an inner end of the positioning block is provided with a correcting groove, and the spring is partially arranged in the correcting groove.

In another embodiment of the present invention, an inner end of the wrench portion is provided with a supporting surface, the spring abuts between the supporting surface and the fixed tooth block, and the nut portion interacts with the supporting surface to axially limit the fixed tooth block.

In another embodiment of the present invention, a second mounting groove is provided on a side of the bottom plate corresponding to the wrench portion, a second mounting block is fixedly mounted in the second mounting groove, and the other end of the pin shaft corresponding to the wrench portion is fixedly connected to the second mounting block.

In another embodiment of the present invention, limiting frames are arranged on two sides of the fixed cutter holder corresponding to the bottom plate, and the limiting frame interacts with the bottom plate in a guiding manner to enable the fixed cutter holder to slide up and down along the bottom plate.

Compared with the prior art, the present invention has the following advantages:

According to the cutter head assembly with a guide structure of the present invention, by means of the guide rod arranged in the bottom plate and the guide groove formed in the movable cutter holder, the movable cutter holder is inserted into the guide rod through the guide groove and is capable of transversely reciprocating along the guide direction: the aforesaid arrangement ensures that the height of the tooth portion of the movable blade is consistent with the height of the tooth portion of the fixed blade during operation, so that the consistency of cutting hair is ensured;

According to the wrench adjustment mechanism of an electric hair cutter of the present invention, when the wrench portion rotates, the fixed cutter holder and the fixed blade are propelled to move along with the bottom plate through the interaction between the driving column and the walls of the second slot: through adopting this design, the front-back distance between the fixed blade and the movable blade is adjusted, allowing that the length of the cut hair to be precisely controlled: through the interaction between the fixed tooth block in the wrench portion and the bevel tooth portion, the wrench portion is accurately positioned; thus, the problems relating to low positioning accuracy, large occupied space and high manufacturing cost of the conventional wrench adjustment mechanism are solved.

### BRIEF DESCRIPTION OF THE DRAWINGS

FIG. 1 is a schematic diagram illustrating an overall structure of the cutter head assembly with a guide structure of the present invention:

FIG. 2 is a schematic diagram illustrating an explosive view of the cutter head assembly with a guide structure of the present invention:

FIG. 3 is a schematic diagram illustrating a sectional view of the cutter head assembly with a guide structure of the present invention:

FIG. 4 is a schematic diagram illustrating an exemplary structure of the bottom plate of the present invention:

FIG. 5 is a schematic diagram illustrating a mounting structure of the oil storage sponge of the present invention:

FIG. 6 is a schematic diagram illustrating an overall structure of the wrench adjustment mechanism of an electric hair cutter of the present invention:

FIG. 7 is a schematic diagram illustrating an explosive view of the wrench adjustment mechanism of an electric hair cutter of the present invention:

FIG. 8 is a schematic diagram illustrating an explosive view of the wrench assembly of the present invention:

FIG. 9 is a schematic diagram illustrating a sectional view of the wrench adjustment mechanism of an electric hair cutter of the present invention:

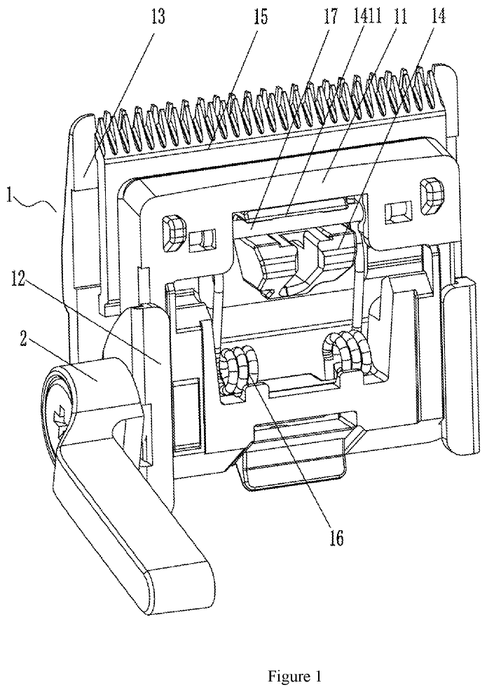

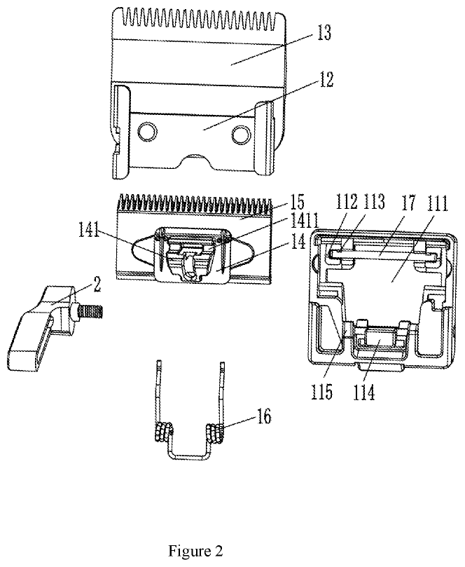

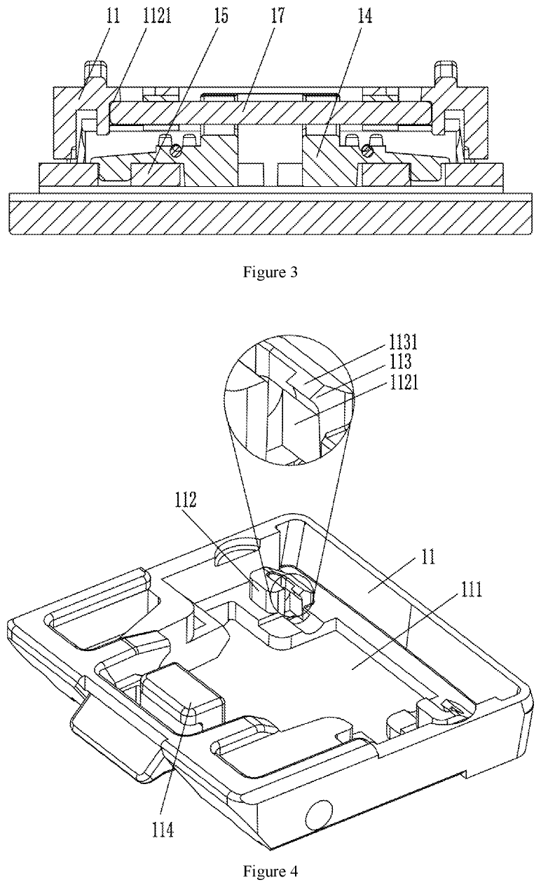

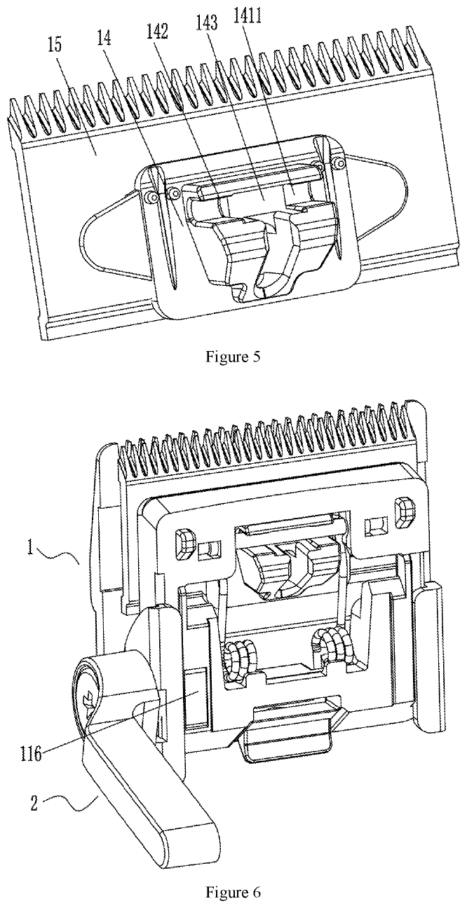

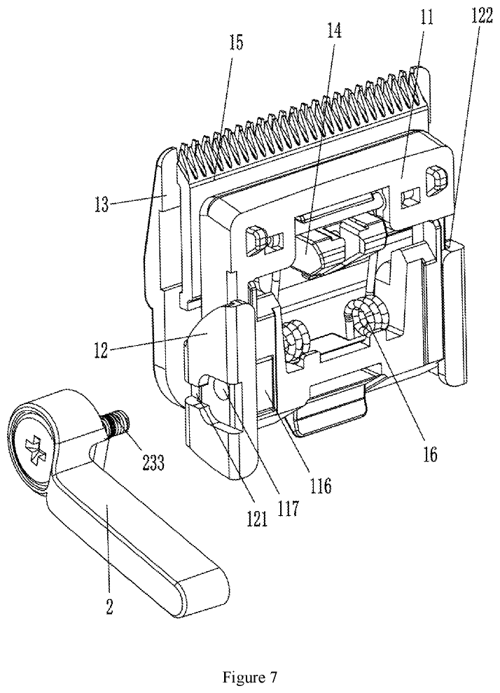

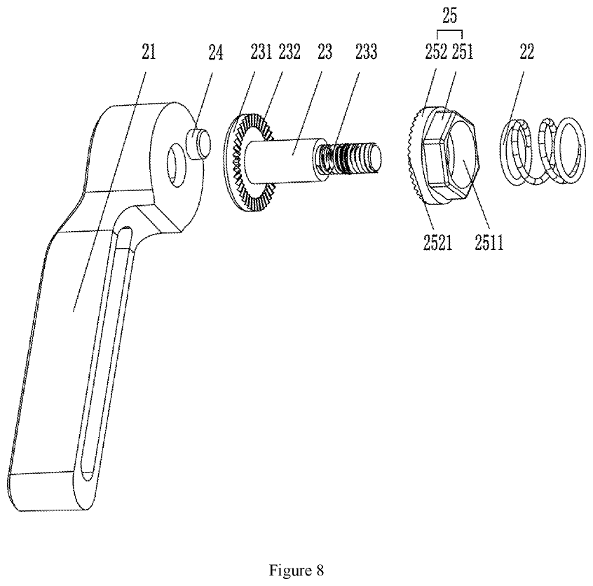

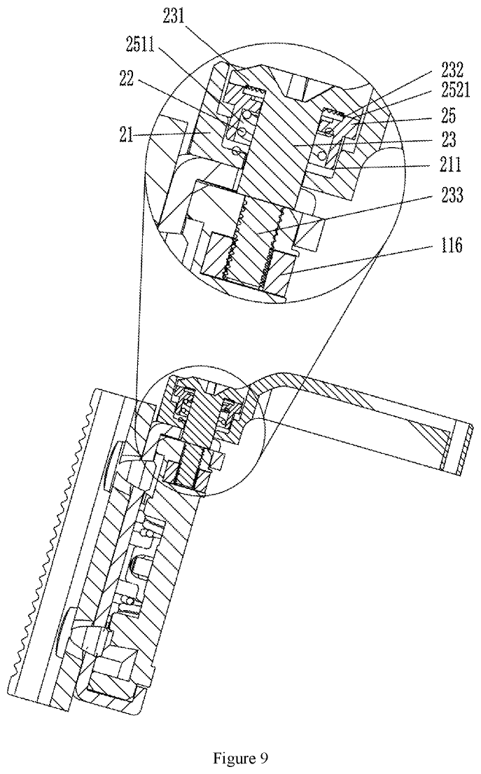

In FIGS. 1-9: 1—Cutter Head Assembly, 11—Bottom Plate, 111—Avoidance Groove, 112—Mounting Portion, 1121—The First Mounting Groove, 113—Limiting Protrusion, 1131—Guide Inclined Surface, 114—Hook, 115—Torsion Spring Mounting Position, 116—The Second Mounting Block, 117—Through Hole, 12—Fixed Cutter Holder, 121—The Second Slot, 122—Limiting Frame, 13—Fixed Blade, 14—Movable Cutter Holder, 141—The First Mounting Block, 1411—Guide Groove, 142—Oil Storage Groove, 143—Oil Storage Sponge, 15—Movable Blade, 16—Torsion Spring, 17—Guide Rod, 2—Wrench Assembly, 21—Wrench Portion, 211—Positioning Groove, 22—Spring, 23—Pin Shaft, 231—Nut Portion, 232—Bevel Tooth Portion, 233—Threaded Portion, 24—Driving Column, 25—Fixed Tooth Block, 251—Positioning Block, 2511—Correcting Groove, 252—Bevel Tooth Block, 2521—Positioning Bevel Tooth Portion.

### DETAILED DESCRIPTION

Drawings are combined hereinafter to further elaborate the technical solution of the present invention.

### Embodiment 1

As shown in FIGS. 1-5, the present invention provides a cutter head assembly with a guide structure. The cutter head assembly 1 comprises a bottom plate 11, a fixed blade holder 12, a fixed blade 13, a movable blade holder 14, a movable blade 15 and a torsion spring 16. The fixed cutter holder 12 is arranged on the bottom plate 11, the fixed blade 13 is fixedly connected to the fixed cutter holder 12, and the movable blade 15 is arranged on the movable cutter holder 14. The movable blade 15 may be fixedly connected to the movable cutter holder 14 or inserted into the movable cutter holder 14 by means of a fastening device, and the movable cutter holder 14 may be connected to the movable blade 15 in a pressing manner under the action of the elastic force of the torsion spring 16. The torsion spring 16 is fixedly mounted on the bottom plate 11 or the fixed cutter holder 12, and two ends of the torsion spring 16 act on the movable cutter holder 14 or the movable blade 15 to enable the movable blade 15 to be attached to the fixed blade 13. In the present invention, a hook 114 is arranged in the middle of the bottom plate 11, torsion spring mounting positions 115 are provided on two sides of the bottom plate 11, and a middle portion of the torsion spring 16 is arranged in the hook 114. The hook 114 is configured to limit the middle portion of the torsion spring 16, and the torsion spring mounting position 115 is configured to transversely limit the torsion spring 16.

A transversely-arranged guide rod 17 is fixedly mounted on the bottom plate 11, and the other end of the movable cutter holder 14 corresponding to the movable blade 15 is provided with a guide groove 1411 interacting with the guide rod 17 in a guiding manner. A portion of the bottom plate 11 corresponding to the movable cutter holder 14 is provided with an avoidance groove 111 for allowing the movable cutter holder 14 to reciprocate transversely.

According to the cutter head assembly with a guide structure of the present invention, by means of the guide rod 17 arranged in the bottom plate 11 and the guide groove 1411 formed in the movable cutter holder 14, the movable cutter holder 14 is inserted into the guide rod 17 through the guide groove 1411 and is capable of transversely reciprocating along the guide direction. The aforesaid arrangement ensures that the height of the tooth portion of the movable blade 15 is consistent with the height of the tooth portion of the fixed blade 13 during operation, so that the consistency of cutting hair is ensured.

Mounting portions 112 are arranged on two sides of the bottom plate 11 corresponding to the avoidance groove 111, a first mounting groove 1121 interacting with an end portion of the guide rod 17 is formed in the mounting portion 112. The end surfaces of two first mounting grooves 1121 limit the guide rod 17 to move in a direction perpendicular to the insertion direction, a limiting protrusion 113 is arranged on the mounting portion 112, and the limiting protrusion 113 limits the guide rod 17 to move along the insertion direction. Through adopting the aforesaid arrangement, the guide rod 17 is fixedly arranged in the first mounting groove 1121, so that the guide rod 17 is prevented from moving or deviating when the electric hair cutter operates.

An upper end of the limiting protrusion 113 is provided with a guide inclined surface 1131 for allowing the guide rod 17 to conveniently insert into the first mounting groove 1121, and by means of the guide inclined surface 1131, the guide rod 17 is fixedly assembled in the first mounting groove 1121.

One end of the movable cutter holder 14 corresponding to the guide rod 17 is provided with a first mounting block 141, and the first mounting block 141 is provided with a guide groove 1411 matched with the outer diameter of the guide rod 17.

The movable cutter holder 14 is inserted into the guide rod 17 through the guide groove 1411 and is capable of reciprocating transversely along the guide rod 17. Further, the longitudinal section of the guide groove 1411 is configured to be a U-shaped structure.

An oil storage groove 142 is provided at an inner end of the movable cutter holder 14 corresponding to the guide groove 1411, and an oil storage sponge 143 is arranged in the oil storage groove 142. The guide rod 17 is in contact with the oil storage sponge 143, and the oil storage sponge 143 is prevented from falling off from the oil storage groove 142 by means of the guide rod 17. The guide rod 17 and the guide groove 1411 are lubricated through the oil storage sponge 143, so that the sliding friction force between the guide rod 17 and the guide groove 1411 is significantly reduced. Through adopting this design, the problem relating to the blocking when the movable cutter holder 14 moves transversely relative to the guide rod 17 is effectively solved.

When the oil storage sponge 143 is not pressed, an outer end of the oil storage sponge 143 extends out from the oil storage groove 142, thereby ensuring that the oil storage sponge 143 is in full contact with the guide rod 17.

In the present invention, an insertion block (not shown) is arranged at the other end of the movable cutter holder 14 corresponding to the guide rod 17, and the movable blade 15 is provided with a first slot (not shown) for interacting with the insertion block. Namely, in this embodiment, the movable blade 15 is inserted into the movable cutter holder 14 when the insertion block is inserted into the first slot.

As shown in FIGS. 1, 2 and 6-9, the fixed cutter holder 12 is slidably arranged on the bottom plate 11, and two sides of the fixed cutter holder 12 are provided with a limiting frame 122 for interacting with the bottom plate 11. A wrench assembly 2 is rotatably mounted on the bottom plate 11 through a pin shaft 23, and a driving column 24 is arranged at an eccentric position of a wrench portion 21 of the wrench assembly 2. The fixed cutter holder 12 is provided with a second slot 121 for interacting with the driving column 24 in an inserting manner, and the wrench portion 21 is rotated to propel the fixed cutter holder 12 to move relative to the bottom plate 11, thereby adjusting the vertical distance between the tooth portion of the fixed blade 13 and the tooth portion of the movable blade 15. In this way, the length of the cut hair is precisely controlled. A positioning mechanism is arranged on the fixed cutter holder 12 or/and the wrench portion 21, and the fixed cutter holder 12 with an adjusted position is fixed through the positioning mechanism.

### Embodiment 2

As shown in FIGS. 6-9, the present invention provides a wrench adjustment mechanism of an electric hair cutter. The wrench adjustment mechanism of an electric hair cutter comprises a cutter head assembly 1 and a wrench assembly 2, wherein the cutter head assembly 1 comprises a bottom plate 11, a fixed cutter holder 12, a fixed blade 13, a movable cutter holder 14, a movable blade 15 and a torsion spring 16. The fixed cutter holder 12 is slidably arranged on the bottom plate 11, the bottom plate 11 is mounted at the front end of the electric hair cutter, and the fixed blade 13 is fixedly mounted on the fixed cutter holder 12. The movable blade 15 is inserted into the movable cutter holder 14 in a limiting manner or fixedly connected to the movable cutter holder 14. The torsion spring 16 is fixedly mounted on the bottom plate 11 or the fixed cutter holder 12, and two ends of the torsion spring 16 act on the movable cutter holder 14 to enable the movable blade 15 to be attached to the fixed blade 13.

The wrench assembly 2 comprises a wrench portion 21 and a spring 22, wherein the wrench portion 21 is rotatably connected to the bottom plate 11 through a pin shaft 23, and a driving column 24 is arranged at an eccentric position at an inner end of the wrench portion 21. The fixed cutter holder 12 is provided with a second slot 121 for interacting with the driving column 24 in an inserting manner, and a fixed tooth block 25 rotating synchronously with the wrench portion 21 is arranged in the wrench portion 21. The wrench portion 21 or the pin shaft 23 is provided with a bevel tooth portion 232 engaged with the tooth surface of the fixed tooth block 25, and the spring 22 abuts between the inner end surface of the wrench portion 21 and the fixed tooth block 25, so that the fixed tooth block 25 possesses a trend of moving towards one side of the bevel tooth portion 232.

According to the wrench adjustment mechanism of an electric hair cutter of the present invention, when the wrench portion 21 rotates, the fixed cutter holder 12 and the fixed blade 13 are propelled to move along with the bottom plate 11 through the interaction between the driving column 24 and the walls of the second slot 121. Through adopting this design, the distance between the fixed blade 13 and the movable blade 15 is adjusted, allowing that the length of the cut hair to be precisely controlled. Through the interaction between the fixed tooth block 25 in the wrench portion 21 and the bevel tooth portion 232, the wrench portion 21 is accurately positioned. Thus, the problems relating to low positioning accuracy, large occupied space and high manufacturing cost of the conventional wrench adjustment mechanism are solved.

An outer side of the pin shaft 23 is provided with a nut portion 231, and the nut portion 231 is used to prevent the wrench portion 21 and the fixed tooth block 25 from being separated from the pin shaft 23. The bevel tooth portion 232 is arranged on an inner end surface of the nut portion 231. In the present invention, the bevel tooth portion 232 is formed on the inner end surface of the nut portion 231, and through the structural design of the pin shaft 23, the pin shaft 23 possess functions of both limiting and positioning. The nut portion 231 and the bevel tooth portion 232 are arranged at an outer end of the pin shaft 23, which help simplify the assembly process of the bevel tooth portion 232 while reducing the occupied space of the whole structure. Thus, the size of the wrench adjustment mechanism becomes smaller.

The other side of the pin shaft 23 corresponding to the nut portion 231 is provided with a threaded portion 233 having an outer diameter smaller than that of the pin shaft 23, and a step portion is formed between the threaded portion 233 and the pin shaft 23. By means of the threaded portion 233, the pin shaft 23 is conveniently assembled to the bottom plate 11, and during the assembly, the pin shaft 23 is screwed to the step portion to abut against a side end of the bottom plate 11.

Further, a second mounting groove is provided on a side of the bottom plate 11 corresponding to the wrench portion 21, a second mounting block 116 is fixedly mounted in the second mounting groove, and the other end of the pin shaft 23 corresponding to the wrench portion 21 is fixedly connected to the second mounting block 116. More specifically, a threaded hole (not shown) in threaded connection with the threaded portion 233 is provided in the second mounting block 116, and the bottom plate 11 is provided with a through hole 117 for allowing the threaded portion 233 to extend into the threaded hole. Because it is inconvenient to position and clamp the bottom plate before processing, by providing the threaded hole on the mounting block, the processing of the bottom plate 11 becomes easier.

The fixed tooth block 25 comprises a positioning block 251 and a bevel tooth block 252 connected to the positioning block 251, wherein the bevel tooth block 252 is provided with a positioning bevel tooth portion 2521 engaged with the tooth surface of the bevel tooth portion 232. An inner wall of the wrench portion 21 is provided with a positioning groove interacting with the positioning block 251. Through the aforesaid arrangement, the fixed tooth block 25 interacts with the positioning groove 211 of the wrench portion 21 in a positioning manner through the positioning block 251, thereby realizing the synchronous rotation with the wrench portion 21. Moreover, an outer end of the fixed tooth block 25 is provided with a positioning bevel tooth portion 2521, and the positioning bevel tooth portion 2521 is engaged with the tooth surface of the bevel tooth portion 232 on the nut to achieve a positioning effect.

An inner end of the positioning block 251 is provided with a correcting groove 2511, and the spring 22 is partially arranged in the correcting groove 2511. By providing the correcting groove 2511 to correct the spring 22, the spring 22 is prevented from deviating when the fixed tooth block 25 rotates along with the wrench portion 21.

An inner end of the wrench portion 21 is provided with a supporting surface, the spring 22 abuts between the supporting surface and the fixed tooth block 25, and the nut portion 231 interacts with the supporting surface to axially limit the fixed tooth block 25. Limiting frames 122 are arranged on two sides of the fixed cutter holder 12 corresponding to the bottom plate 11, and the limiting frame 122 interacts with the bottom plate 11 in a guiding manner to enable the fixed cutter holder 12 to slide up and down along the bottom plate 11.

Definitely, as an equivalent replacement, guide grooves may also be provided on two sides of the bottom plate 11, and guide blocks interacting with the guide grooves in a guiding manner are provided on two sides of the fixed cutter holder 12.

The above are merely preferred embodiments of the present invention, and therefore, the equivalent changes or modifications made according to the structures, features and principles described in the present invention shall fall into the scope defined by the claims of the present invention.

1. A cutter head assembly with a guide structure, comprising:
a bottom plate (11),
a fixed blade holder (12),
a fixed blade (13),
a movable blade holder (14),
a movable blade (15), and
a torsion spring (16),
wherein the fixed cutter holder (12) is slidably arranged on the bottom plate (11), the fixed blade (13) is fixedly connected to the fixed cutter holder (12), and the movable blade (15) is arranged on the movable cutter holder (14), wherein the torsion spring (16) is fixedly mounted on the bottom plate (11) or the fixed cutter holder (12), wherein two ends of the torsion spring (16) act on the movable cutter holder (14) or the movable blade (15) to enable the movable blade (15) to be attached to the fixed blade (13), wherein a transversely-arranged guide rod (17) is fixedly mounted on the bottom plate (11), and an end of the movable cutter holder (14) corresponding to the movable blade (15) is provided with a guide groove (1411) interacting with the guide rod (17) in a guiding manner, wherein a portion of the bottom plate (11) corresponding to the movable cutter holder (14) is provided with an avoidance groove (111) for allowing the movable cutter holder (14) to reciprocate transversely.

2. The cutter head assembly with a guide structure of claim 1, wherein mounting portions (112) are arranged on two sides of the bottom plate (11) corresponding to the avoidance groove (111), wherein a first mounting groove (1121) interacting with an end portion of the guide rod (17) is formed in the mounting portion (112), wherein end surfaces of two first mounting grooves (1121) limit the guide rod (17) to move in a direction perpendicular to the insertion direction, wherein a limiting protrusion (113) is arranged on the mounting portion (112), and wherein the limiting protrusion (113) limits the guide rod (17) to move along the insertion direction.

3. The cutter head assembly with a guide structure of claim 2, wherein an upper end of the limiting protrusion (113) is provided with a guide inclined surface (1131) for allowing the guide rod (17) to be inserted into the first mounting groove (1121).

4. The cutter head assembly with a guide structure of claim 1, wherein the end of the movable cutter holder (14) corresponding to the guide rod (17) is provided with a first mounting block (141), wherein the first mounting block (141) is provided with a guide groove (1411) matched with the outer diameter of the guide rod (17), wherein the movable cutter holder (14) is inserted into the guide rod (17) through the guide groove (1411) and is capable of reciprocating transversely along the guide rod (17).

5. The cutter head assembly with a guide structure of claim 4, wherein a longitudinal section of the guide groove (1411) is configured to be a U-shaped structure.

6. The cutter head assembly with a guide structure of claim 1, wherein an oil storage groove (142) is provided at an inner end of the movable cutter holder (14) corresponding to the guide groove (1411), wherein an oil storage sponge (143) is arranged in the oil storage groove (142), wherein the guide rod (17) is in contact with the oil storage sponge (143), wherein the oil storage sponge (143) is prevented from falling off from the oil storage groove (142) by the guide rod (17).

7. The cutter head assembly with a guide structure of claim 6, wherein when the oil storage sponge (143) is not pressed, an outer end of the oil storage sponge (143) extends out from the oil storage groove (142).

8. The cutter head assembly with a guide structure of claim 1, wherein an insertion block is arranged at the end of the movable cutter holder (14) corresponding to the guide rod (17), wherein the movable blade (15) is provided with a first slot for interacting with the insertion block.

9. A wrench adjustment mechanism of an electric hair cutter, comprising:
a cutter head assembly (1), and
a wrench assembly (2),
wherein the cutter head assembly (1) further comprising: a bottom plate (11), a fixed cutter holder (12), a fixed blade (13), a movable cutter holder (14), a movable blade (15) and a torsion spring (16), wherein the fixed cutter holder (12) is slidably arranged on the bottom plate (11), wherein the wrench assembly (2) further comprising: a wrench portion (21) and a spring (22), wherein the wrench portion (21) is rotatably connected to the bottom plate (11) through a pin shaft (23), wherein a driving column (24) is arranged at an eccentric position at an inner end of the wrench portion (21), wherein the fixed cutter holder (12) is provided with a second slot (121) for interacting with the driving column (24) in an inserting manner, wherein a fixed tooth block (25) rotating synchronously with the wrench portion (21) is arranged in the wrench portion (21), wherein the wrench portion (21) or the pin shaft (23) is provided with a bevel tooth portion (232) engaged with the tooth surface of the fixed tooth block (25), wherein the spring (22) is disposed between the inner end surface of the wrench portion (21) and the fixed tooth block (25).

10. The wrench adjustment mechanism of an electric hair cutter of claim 9, wherein an outer side of the pin shaft (23) is provided with a nut portion (231), wherein the nut portion (231) is used to prevent the wrench portion (21) and the fixed tooth block (25) from being separated from the pin shaft (23), wherein the bevel tooth portion (232) is arranged on an inner end surface of the nut portion (231).

11. The wrench adjustment mechanism of an electric hair cutter of claim 10, wherein the side of the pin shaft (23) corresponding to the nut portion (231) is provided with a threaded portion (233) having an outer diameter smaller than that of the pin shaft (23), wherein a step portion is formed between the threaded portion (233) and the pin shaft (23).

12. The wrench adjustment mechanism of an electric hair cutter of claim 9, wherein the fixed tooth block (25) further comprising:
a positioning block (251) and a bevel tooth block (252) connected to the positioning block (251), wherein the bevel tooth block (252) is provided with a positioning bevel tooth portion (2521) engaged with the tooth surface of the bevel tooth portion (232), wherein an inner wall of the wrench portion (21) is provided with a positioning groove interacting with the positioning block (251).

13. The wrench adjustment mechanism of an electric hair cutter of claim 12, wherein an inner end of the positioning block (251) is provided with a correcting groove (2511), wherein the spring (22) is partially arranged in the correcting groove (2511).

14. The wrench adjustment mechanism of an electric hair cutter of claim 10, wherein an inner end of the wrench portion (21) is provided with a supporting surface, wherein the spring (22) is disposed between the supporting surface and the fixed tooth block (25), wherein the nut portion (231) interacts with the supporting surface to axially limit the fixed tooth block (25).

15. The wrench adjustment mechanism of an electric hair cutter of claim 9, wherein a second mounting groove is provided on a side of the bottom plate (11) corresponding to the wrench portion (21), wherein a second mounting block (116) is fixedly mounted in the second mounting groove, wherein the end of the pin shaft (23) corresponding to the wrench portion (21) is fixedly connected to the second mounting block (116).

16. The wrench adjustment mechanism of an electric hair cutter of claim 9, wherein limiting frames (122) are arranged on two sides of the fixed cutter holder (12) corresponding to the bottom plate (11), wherein the limiting frame (122) interacts with the bottom plate (11) in a guiding manner to enable the fixed cutter holder (12) to slide up and down along the bottom plate (11).
